(19) United States
(12) Patent Application Publication
(10) Pub. No.: US 2025/0316993 A1
(43) Pub. Date: Oct. 9, 2025

(54) VEHICULAR CHARGING SYSTEM, CHARGING CIRCUIT, CHARGING DEVICE, AND VOLTAGE CONTROL METHOD

(71) Applicant: KABUSHIKI KAISHA TOYOTA JIDOSHOKKI, Aichi-ken (JP)

(72) Inventor: Takahiro SUZUKI, Kariya shi (JP)

(73) Assignee: KABUSHIKI KAISHA TOYOTA JIDOSHOKKI, Aichi-ken (JP)

(21) Appl. No.: 19/171,580

(22) Filed: Apr. 7, 2025

(30) Foreign Application Priority Data
Apr. 8, 2024 (JP) 2024-061912

(51) Int. Cl. H02J 7/00; B60L 53/20; B60L 53/62

(52) U.S. Cl. CPC H02J 7/0024; B60L 53/20; B60L 53/62; H02J 7/00032; B60L 2210/10; H02J 2207/20

(57) ABSTRACT

When a voltage supplied to a first connector is a DC voltage and a voltage of a battery is higher than a predetermined value, an ECU closes a first switch device to thereby apply the DC voltage from a pair of first power lines to an auxiliary DDC. When a voltage supplied to the first connector is a DC voltage and a voltage of the battery is lower than the predetermined value, the ECU opens the first switch device and actuates at least one of a PFC and an insulated DCDC converter to thereby apply the DC voltage transformed by a charging circuit to an auxiliary group.

### CROSS REFERENCE TO RELATED APPLICATIONS

This nonprovisional application is based on Japanese Patent Application No. 2024-061912 filed on Apr. 8, 2024 with the Japan Patent Office, the entire contents of which are hereby incorporated by reference.

### BACKGROUND

The present disclosure relates to a vehicular charging system, a charging circuit, a charging device, and a voltage control method.

### Description of the Background Art

Japanese Patent Laying-Open No. 2021-141545 discloses a power supply system for an electrically powered vehicle. In this power supply system, a DC voltage is supplied, from an external charger installed at a charging station, to the electrically powered vehicle to charge its battery. Specifically, the power supply system includes a DC power supply inlet, and charges the battery with a DC voltage that is supplied from the external charger and is appropriate for a state of the battery. When the state of charge of the battery is low and the battery voltage is lower than the normal one, the supplied DC voltage is also low. This charging is also referred to as fast charging.

Moreover, Japanese Patent Laying-Open No. 2023-047162 discloses a technique for switching connection of cells constituting a battery, between series connection and parallel connection, depending on whether the battery is charged or discharged.

### SUMMARY

In general, an electrically powered vehicle includes an auxiliary DCDC converter that steps down a battery voltage from 400 V to 14 V, for example, and supplies the resultant battery voltage in order to cause a group of auxiliaries of the vehicle to operate. The group of auxiliaries includes an ECU (Electronic Control Unit) for controlling the vehicle, a charging relay, an air conditioning device, a battery temperature conditioning device, an audio device, and the like. These devices included in the group of auxiliaries are desired to also operate while the battery is being charged. That is, it is preferable for an electrically powered vehicle to have stable electric power supplied to a group of auxiliaries even while the battery is being charged.

However, in some cases, supply of stable electric power to a group of auxiliaries is impossible due to variation of the battery voltage during charging. These cases include a first case and a second case. The first case refers to a case where a DC voltage supplied from a charger is low because the state of charge of the battery is low and the battery voltage is lower than the normal one. The second case refers to a case where connection of cells constituting the battery is switched between series connection and parallel connection, depending on whether the battery is charged or discharged.

The present disclosure is made to solve the problems as described above, and an object according to an aspect is to supply stable electric power to a group of auxiliaries regardless of the battery voltage during charging of the battery.

A vehicular charging system of the present disclosure is mounted on a vehicle. The charging system includes: a battery that stores electric power for generating driving force of the vehicle; a first connector to which at least a DC voltage is supplied from an external charger; and a pair of first power lines that connects the battery and the first connector to each other. The charging system also includes: a charging circuit that charges the battery by converting an AC voltage supplied from the external charger into a DC voltage and outputting the DC voltage to the pair of first power lines; an auxiliary DCDC converter that converts a voltage of the battery input from the pair of first power lines, and supplies the converted voltage to an auxiliary group including at least an auxiliary; a first switch device disposed between the pair of first power lines, and an output of the charging circuit and an input of the auxiliary DCDC converter; and a control circuit. The charging circuit include: a power factor correction circuit; and a charging DCDC converter that converts a DC voltage output from the power factor correction circuit. When a predetermined condition regarding charging of the battery is satisfied, the control circuit is configured to open the first switch device to disconnect the pair of first power lines from the output of the charging circuit and the input of the auxiliary DCDC converter, supply a DC voltage supplied to the first connector to the charging circuit, and actuate at least one of the power factor correction circuit and the charging DCDC converter, to thereby supply the DC voltage converted by the charging circuit to the auxiliary group.

A charging circuit of the present disclosure is mounted on a vehicle including a battery that stores electric power for generating driving force of the vehicle, and the charging circuit is a circuit that charges the battery. The vehicle includes: a first connector to which at least a DC voltage is supplied from an external charger; a pair of first power lines that connects the battery and the first connector to each other; an auxiliary DCDC converter that converts a voltage of the battery input from the pair of first power lines, and supplies the converted voltage to an auxiliary group including at least an auxiliary; and a first switch device disposed between the pair of first power lines, and an output of the charging circuit and an input of the auxiliary DCDC converter. The charging circuit includes: a power factor correction circuit; and a charging DCDC converter that converts a DC voltage output from the power factor correction circuit. The charging circuit charges the battery by converting an AC voltage supplied from the external charger into a DC voltage and outputting the DC voltage to the pair of first power lines. When a predetermined condition regarding charging of the battery is satisfied, the charging circuit opens the first switch device to disconnect the pair of first power lines from the output of the charging circuit and the input of the auxiliary DCDC converter, supplies a DC voltage supplied to the first connector to the charging circuit, and actuates at least one of the power factor correction circuit and the charging DCDC converter, to thereby supply the DC voltage converted by the charging circuit to the auxiliary group.

A control method of the present disclosure is a voltage control method for a vehicle. The vehicle includes: a battery that stores electric power for generating driving force of the vehicle; a first connector to which at least a DC voltage is supplied from an external charger; a pair of first power lines that connects the battery and the first connector to each other; a charging circuit that charges the battery by converting an AC voltage supplied from the external charger into a DC voltage and outputting the DC voltage to the pair of first power lines; an auxiliary DCDC converter that converts a voltage of the battery input from the pair of first power lines, and supplies the converted voltage to an auxiliary group including at least an auxiliary; and a first switch device disposed between the pair of first power lines, and an output of the charging circuit and an input of the auxiliary DCDC converter. The charging circuit includes: a power factor correction circuit; and a charging DCDC converter that converts a DC voltage output from the power factor correction circuit. The voltage control method includes, when a predetermined condition regarding charging of the battery is satisfied, opening the first switch device to disconnect the pair of first power lines from the output of the charging circuit and the input of the auxiliary DCDC converter, supplying a DC voltage supplied to the first connector to the charging circuit, and actuating at least one of the power factor correction circuit and the charging DCDC converter, to thereby supply the DC voltage converted by the charging circuit to the auxiliary group.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a block diagram showing a configuration of a vehicle.

FIG. 2 is a block diagram of a charging system according to Embodiment 1.

FIG. 3 is a flowchart of a process performed by an ECU according to Embodiment 1.

FIG. 4 is a block diagram of a charging system according to Embodiment 2.

FIG. 5 is a flowchart of a process performed by an ECU according to Embodiment 2.

FIG. 6 is a block diagram of a charging system according to Embodiment 3.

FIG. 7 is a block diagram of a charging system according to Embodiment 4.

FIG. 8 is a block diagram of a charging system according to Embodiment 5.

FIG. 9 is a block diagram of a charging system according to Embodiment 6.

FIG. 10 is a block diagram of another charging system according to Embodiment 6.

FIG. 11 is a block diagram of a charging system according to Embodiment 7.

FIG. 12 is a block diagram of another charging system according to Embodiment 7.

FIG. 13 is a block diagram of another charging system according to Embodiment 7.

### DESCRIPTION OF THE PREFERRED EMBODIMENTS

Embodiments of the present disclosure are hereinafter described in detail with reference to the drawings. In the drawings, the same or corresponding parts are denoted by the same reference characters, and a description thereof is not herein repeated.

### Embodiment 1

### Charging System

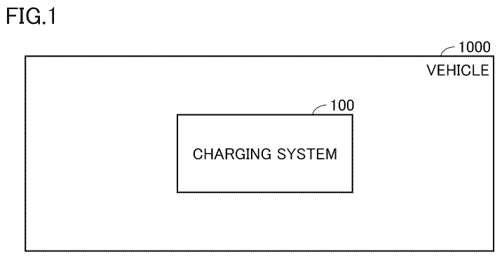

FIG. 1 is a block diagram showing a configuration of a vehicle. A charging system 100 of the present embodiment is mounted on a vehicle 1000. The vehicle 1000 is an electrically powered vehicle. Thus, the charging system 100 is a charging system for the vehicle 1000.

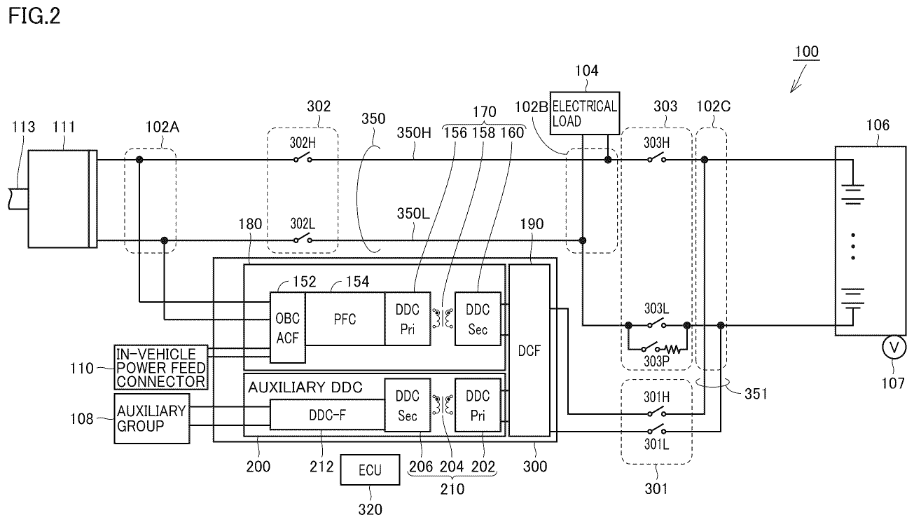

FIG. 2 is a block diagram of the charging system 100 according to the present embodiment. The charging system 100 includes an ECU 320, a first connector 111, a pair of first power lines 350, an electrical load 104, a battery 106, a charging device 300, a group of auxiliaries also referred to herein as an auxiliary group 108, an in-vehicle power feed connector 110, and a sensor 107. The pair of first power lines 350 corresponds to “a pair of first power lines” of the present disclosure.

A charger 113 installed, for example, at a charging station is inserted into the first connector 111, and an AC (Alternating Current) voltage or a DC (Direct Current) voltage is applied from the charger 113. The ECU 320 can identify which of the DC voltage and the AC voltage is supplied from the first connector 111. For example, the charger 113 transmits, to the ECU 320, a voltage type signal indicating whether the voltage is an AC voltage or a DC voltage. Based on this voltage type signal, the ECU 320 can identify which of the AC voltage and the DC voltage is supplied.

The battery 106 is a high-voltage battery that is a 400 V battery, for example. The sensor 107 detects the voltage of the battery 106. The sensor 107 detects the voltage based on, for example, a state of charge (SOC) of the battery 106.

The charging device 300 includes a charging circuit 180, a DCF (Direct Current Filter) 190, and an auxiliary DDC 200. The charging circuit 180 is typically an on-board charger. The charging circuit 180 converts an AC voltage supplied to the first connector 111 into a DC voltage to charge the battery 106. The auxiliary DDC 200 corresponds to “auxiliary DCDC converter” of the present disclosure.

The charging circuit 180 includes an OBCACF (On-Board Charger Alternating Current Filter) 152, a PFC (Power Factor Correction) 154, and an insulated DCDC Converter 170. The insulated DCDC converter 170 includes a primary circuit 156, a transformer 158, and a secondary circuit 160. The insulated DCDC converter 170 corresponds to “charging DCDC converter” of the present disclosure.

The OBCACF 152 suppresses noise transmitted to a commercial AC line (first connector 111) and noise input to the charging circuit 180. The PFC 154 improves the power factor of AC power supplied from the OBCACF 152. The PFC 154 corresponds to “power factor correction circuit” of the present disclosure. Further, the PFC 154 converts (rectifies) the AC voltage of the AC power with the improved power factor into a DC voltage. The insulated DCDC converter 170 converts the DC voltage supplied from the PFC 254. In the present embodiment, it is supposed that the conversion is “voltage step-up.”

The charging circuit 180 is capable of bidirectional operation. The insulated DCDC converter 170 of the charging circuit 180 converts a DC voltage supplied from the battery 106, and the PFC 154 converts the resultant DC voltage into an AC voltage (performs DC/AC conversion) to supply the AC power to the in-vehicle power feed connector 110. The voltage to be fed is, for example, AC 100 V for home use.

The DCF 190 is a filter, and suppresses noise of a voltage supplied to the battery 106 and noise of a voltage supplied from the battery 106.

The auxiliary DDC 200 supplies electric power to the auxiliary group 108. The auxiliary group 108 includes at least an auxiliary. Examples of the auxiliary include, for example, the ECU 320, a plurality of switch devices described later herein, an in-vehicle air conditioner (not shown), a temperature conditioner (not shown) that adjusts the temperature of the battery 106, and the like. The auxiliary group may also include an auxiliary battery for auxiliaries.

The auxiliary DDC 200 includes an insulated DCDC converter 210 and a DDC-F (Filter of the auxiliary DDC 200) 212. The insulated DCDC converter 210 includes a primary circuit 202, a transformer 204, and a secondary circuit 206.

The pair of first power lines 350 is power lines connecting the first connector 111 and the battery 106 to each other. That is, one end of the pair of first power lines 350 is connected to the first connector 111, and the other end of the pair of first power lines 350 is connected to the battery 106. The pair of first power lines 350 includes a pair of a high-voltage power line 350H through which a high-voltage current flows and a low-voltage power line 350L through which a low-voltage current flows.

The pair of first power lines 350 is equipped with a first node 102A, a second node 102B, and a third node 102C. The second node 102B is located closer to the battery 106 than the first node 102A. The third node 102C is located closer to the battery 106 than the second node 102B.

At the first node 102A, power lines are branched from the pair of first power lines 350. The branched power lines are connected to an OBCACF (On-Board Charger Alternating Current Filter) 152 included in the charging circuit 180.

At the second node 102B, power lines are branched from the pair of first power lines 350. The branched power lines are connected to the electrical load 104. The electrical load 104 is a load that generates driving force of the vehicle 1000, from the electric power of the battery 106. The electrical load 104 is, for example, a traction inverter.

At the third node 102C, power lines are branched from the pair of first power lines 350. The branched power lines 351 are connected to the DCF (Direct Current Filter) 190 included in the charging device 300. The power lines 351 are connected to both the charging circuit 180 and the auxiliary DDC 200 in the DCF 190, which, however, is not shown.

The charging system 100 further includes a plurality of switch devices. The plurality of switch devices include a first switch device 301, a second switch device 302, and a third switch device 303. One switch device includes a high-voltage side relay provided on the high-voltage side power line and a low-voltage side relay provided on the low-voltage side power line. For example, the first switch device 301 includes a high-voltage side relay 301H and a low-voltage side relay 301L. The first switch device 301 is disposed between the pair of first power lines 350, and the output side (secondary circuit 160) of the charging circuit 180 and the input side (primary circuit 202) of the auxiliary DDC 200.

In the present disclosure, “to open a switch device” means “to open both the high-voltage side relay and the low-voltage side relay that are included in the switch device.” As the switch device is opened, electricity is not conducted (cannot be conducted) at the switch device. In contrast, “to close a switch device” means “to close both the high-voltage side relay and the low-voltage side relay that are included in the switch device.” As the switch device is closed, electricity is conducted (can be conducted) at the switch device.

The third switch device 303 includes a relay 303H and a relay 303L, as well as a relay 303P connected to a resistor. For example, the charging system 100 closes the relay 303H and the relay 303P for pre-charging a capacitor of the electrical load 104 when the vehicle 1000 is started. Accordingly, the electric current can be reduced by the resistor connected to the relay 303P, so that an inrush current can be prevented from flowing through the capacitor.

The ECU 320 performs control of charging by an external power supply, control of opening/closing of a plurality of switch devices, and control of the charging device 300, for example. The ECU 320 corresponds to “control circuit” of the present disclosure.

### Control by ECU 320

Next, control by the ECU 320 is described. The ECU 320 performs control of opening/closing of a plurality of switch devices and control of the charging device 300. Accordingly, the state of the vehicle 1000 (charging system 100) can be switched to any of a plurality of states. The plurality of states include a battery discharging state, an AC charging state, and a DC charging state.

Initially, the battery discharging state is described. The battery discharging state is a state in which the battery 106 is being discharged which is, for example, a state in which the vehicle 1000 is being driven (is travelling). The ECU 320 sets the state of the charging system 100 to the battery discharging state by closing the first switch device 301, opening the second switch device 302, and closing the third switch device 303.

In the battery discharging state, electric power from the battery 106 is applied to the electrical load 104 and the DCF 190. Further, electric power from the DCF 190 is applied to the charging circuit 180 and the auxiliary DDC 200. Electric power from the charging circuit 180 is applied to the in-vehicle power feed connector 110 by reverse operation of the insulated DCDC converter 170 and the above-described DC/AC conversion operation by the PFC 154. The voltage applied to the in-vehicle power feed connector 110 is AC 100 V for home use, for example. Further, electric power from the auxiliary DDC 200 is applied to the auxiliary group 108.

Next, the AC charging state is described. The AC charging state is a state in which an AC voltage is supplied from the first connector 111 to charge the battery 106. Identifying that an AC voltage is applied from the charger 113, the ECU 320 opens the second switch device 302 and closes the first switch device 301 and the third switch device 303.

Either the second switch device 302 or the third switch device 303 may be open. However, if both the second switch device 302 and the third switch device 303 are open, it is possible to prevent electric power from being unintentionally supplied to the electrical load 104.

In the AC charging state, the AC power supplied from the first connector is applied to the OBCACF 152. The OBCACF 152 suppresses noise input to the charging circuit 180.

The PFC 154 improves the power factor of the AC power supplied from the OBCACF 152. Further, the PFC 154 converts (rectifies) the AC voltage of the AC power with the improved power factor into a DC voltage. The insulated DCDC converter 170 converts the DC voltage supplied from the PFC 154.

The DCF 190 suppresses noise of the voltage supplied from the insulated DCDC converter 170. The voltage from the DCF 190 is applied to the auxiliary DDC 200 and the battery 106. Thus, the electric power is supplied from the DCF 190 to the auxiliary DDC 200 and the battery 106. The auxiliary DDC 200 supplies the electric power from the charging circuit 180 (insulated DCDC converter 170) or the battery 106 to the auxiliary group 108 (auxiliary(ies), auxiliary battery). The auxiliary battery is charged with the supplied electric power.

Next, the DC charging (fast charging) state is described. For performing the DC charging, the ECU 320 acquires the voltage, detected by the sensor 107, of the battery 106 before undergoing DC charging. Then, the ECU 320 transmits a request signal to the charger 113. The request signal is a signal for requesting the charger 113 for a start-time voltage that is a voltage at the start of charging of the battery 106 with a DC voltage. The start-time voltage is a voltage to be applied from a start timing at which charging by the charger 113 is started to a timing at which a predetermined short time (for example, 3 seconds) has elapsed. The start-time voltage is also referred to as start voltage.

Specifically, in the case where the voltage detected by the sensor 107 (the voltage of the battery 106 before being charged) is higher than or equal to a predetermined value, the ECU 320 transmits a request signal for requesting the charger 113 for a high voltage to be used as a voltage at the time charging is started. The predetermined value is a value determined in advance. Then, the ECU 320 closes the first switch device 301, the second switch device 302, and the third switch device 303, and causes the charging circuit 180 not to perform charging. Accordingly, a sufficient voltage is supplied from the charger 113 to the battery 106. Moreover, the potential of the third node 102C becomes a high potential. Therefore, the current flowing through the pair of first power lines 350 can be branched at the third node 102C and the branched current can be supplied to the charging device 300 through the pair of power lines 351. The charging device 300 can cause the current to flow to the in-vehicle power feed connector 110 and the auxiliary group 108. Thus, the ECU 320 can supply stable electric power to the in-vehicle power feed connector 110 and the auxiliary group 108.

In contrast, there is a case where the voltage detected by the sensor 107 is lower than the predetermined value (the case where the electric power of the battery 106 has been exhausted). In this case, if DC charging is started with the same voltage as that when the voltage detected by the sensor 107 is higher than or equal to the predetermined value, a large amount of current tends to flow from the charger 113 to the battery 106. In this case, if a high voltage is supplied from the charger 113 to the battery 106, damage to the battery 106, for example, may occur.

In view of this, in order to suppress damage to the battery 106, for example, the ECU 320 transmits to the charger 113, in the case where the voltage of the battery 106 before being charged is lower than the predetermined value, a request signal for requesting the charger 113 for a low voltage. The low voltage is a voltage higher than the voltage of the battery 106 before being charged.

That is, the start-time voltage requested by the request signal in the case where the voltage of the battery 106 is lower than the predetermined value is lower than the start-time voltage requested by the request signal in the case where the voltage of the battery 106 is higher than the predetermined value. The control for changing the level of the start-time voltage depending on the level of the voltage of the battery 106 before being charged is also referred to as “voltage control” hereinafter.

However, if a request for a low voltage is made to the charger 113, damage to the battery 106, for example, can be suppressed, while sufficient electric power cannot be supplied to the auxiliary DDC 200. As described above, the auxiliary DDC 200 supplies electric power to the auxiliary group 108, the ECU 320, the first switch device 301, the second switch device 302, and the third switch device 303, for example. Therefore, if the start voltage from the charger 113 is low, the auxiliary DDC 200 may not be able to supply sufficient electric power to the auxiliary group 108, the ECU 320, the first switch device 301, the second switch device 302, and the third switch device 303, for example, during DC charging of the battery 106.

In view of this, in the present embodiment, in the case where the voltage detected by the sensor 107 is lower than the predetermined value, the ECU 320 causes the charging circuit 180 to step up the low voltage from the charger 113 and supply the resultant voltage to the auxiliary DDC 200. Specifically, the ECU 320 opens the first switch device 301 and closes the second switch device 302 and the third switch device 303. Further, the ECU 320 actuates the charging circuit 180.

Accordingly, the electric current from the charger 113 flows to the OBCACF 152. Thus, the DC voltage supplied from the first connector 111 is applied to the OBCACF 152. The OBCACF 152 suppresses noise of the DC voltage.

The PFC 154 steps up the DC voltage (low voltage) supplied from the OBCACF 152. The PFC 154 is configured as any of a bridge type PFC circuit, a bridgeless PFC circuit, a totem pole type PFC circuit, and the like. It is therefore possible for the PFC 154 to step up the DC voltage.

In particular, in the present embodiment, the charging circuit 180 enables AC 100 V for home use to be supplied to the in-vehicle power feed connector 110. Therefore, the PFC 154 in the charging circuit 180 is configured as a PFC circuit in which diodes are all replaced with switching elements. The PFC circuit in which the switching elements are used is, for example, a bridgeless PFC circuit or a totem pole type PFC circuit.

The insulated DCDC converter 170 further steps up the stepped-up DC voltage supplied from the PFC 154 to a voltage with which the auxiliary DDC 200 can operate stably. Thus, in the present embodiment, the charging circuit 180 that converts the AC voltage into the DC voltage during AC charging functions as a transformer circuit (voltage step-up circuit) for the DC voltage in the case where the voltage of the battery 106 before being charged is lower than the predetermined value. In the present embodiment, both the PFC 154 and the insulated DCDC converter 170 of the charging circuit 180 function as a transformer circuit (voltage step-up circuit). However, in a modification, either the PFC 154 or the insulated DCDC converter 170 may function as a transformer circuit (voltage step-up circuit).

The DCF 190 suppresses noise of the stepped-up DC voltage supplied by the insulated DCDC converter 170. The voltage from the DCF 190 (voltage generated in the DCF 190) is applied to the auxiliary DDC 200.

The DC voltage from the first connector 111 is supplied to the battery 106 through the second switch device 302 and the third switch device 303. Accordingly, the electric power from the DCF 190 is supplied to the auxiliary DDC 200. Since the first switch device 301 is opened, the pair of first power lines 350 is disconnected from the output (secondary circuit 160) of the charging circuit 180 and the input (primary circuit 202) of the auxiliary DDC 200. Thus, it is possible to prevent electric current from the DCF 190 from flowing into the battery 106 or electric current from the battery 106 from flowing into the DCF 190.

Then, the auxiliary DDC 200 supplies the stable electric power from the DCF 190 to the auxiliary group (auxiliary(ies), auxiliary battery). The auxiliary battery is charged with the supplied electric power.

### Flowchart

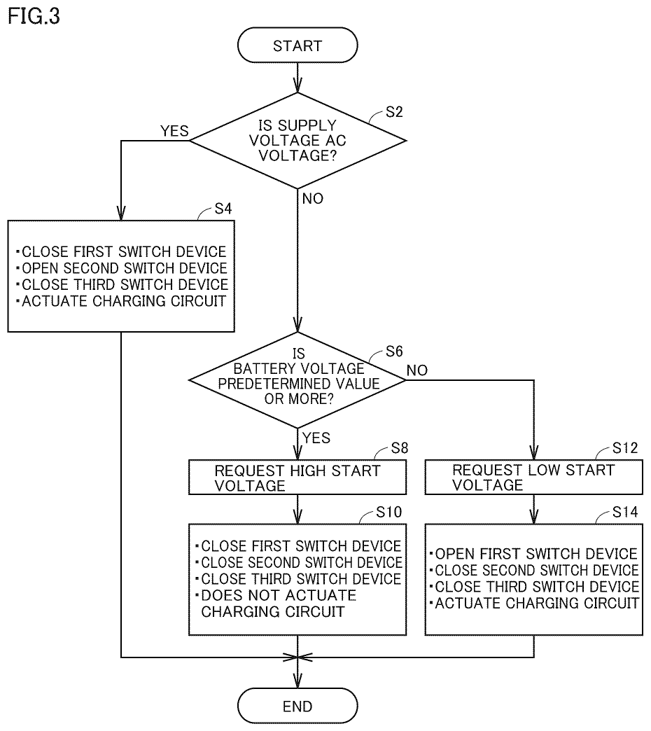

FIG. 3 is a flowchart of a process performed by the ECU 320 according to the present embodiment. Initially, in step S2, the ECU 320 determines whether a supply voltage supplied from the charger 113 is an AC voltage or a DC voltage, based on a voltage type signal from the charger 113. When the supply voltage is the AC voltage (YES in step S2), the process proceeds to step S4.

In step S4, the ECU 320 closes the first switch device 301, opens the second switch device 302, and closes the third switch device 303. Further, the ECU 320 actuates the charging circuit 180. By performing the process of step S4, the ECU 320 can improve the power factor of the AC voltage by the charging circuit 180, convert the AC voltage into a DC voltage, and supply the resultant electric power to the battery 106 and the auxiliary DDC 200.

In contrast, when the supply voltage is the DC voltage in step S2 (NO in step S2), the ECU 320 determines, in step S6, whether or not the voltage of the battery 106 is higher than or equal to a predetermined value. When the voltage of the battery 106 is higher than or equal to the predetermined value (YES in step S6), the ECU 320 requests, in step S8, the charger 113 for a high start voltage. Next, in step S10, the ECU 320 closes all of the first switch device 301, the second switch device 302, and the third switch device 303. Further, the ECU 320 causes the charging circuit 180 not to perform charging. By performing the process of step S10, the ECU 320 can supply electric power to the battery 106 and the auxiliary DDC 200.

In contrast, when the voltage of the battery 106 is less than the predetermined value in step S6 (NO in step S6), the ECU 320 requests the charger 113 for a low start voltage in step S12. Next, in step S14, the ECU 320 opens the first switch device 301 and closes the second switch device 302 and the third switch device 303. Further, the ECU 320 actuates the charging circuit 180. By performing the process of step S14, the ECU 320 can charge the battery 106 and supply stable electric power to the auxiliary DDC 200, i.e., the auxiliary group 108, even when the start voltage is low.

The condition that the voltage of the battery 106 is less than the predetermined value in step S6 (NO in step S6) corresponds to an example of “a predetermined condition regarding charging of the battery” of the present disclosure. That is, when the predetermined condition is satisfied (when the result of the determination is NO in step S6), the ECU 320 perform the process of step S14.

### Intermediate Summary

As seen from the foregoing, in the present embodiment, the charging system 100 performs the above-described voltage control (steps S8 and S12) in order to protect the battery 106. It is therefore possible to suppress damage to the battery 106. In the case where the voltage of the battery 106 before being charged is higher than the predetermined value (YES in step S6), all of the first switch device 301, the second switch device 302, and the third switch device 303 are closed (step S10). Thus, a sufficient voltage can be applied to the battery 106 and the auxiliary DDC 200.

In contrast, in the case where the voltage of the battery 106 before being charged is lower than the predetermined value and the voltage control as described above is performed, a sufficient voltage cannot be applied to the charging device 300. In the case where a sufficient voltage cannot be applied to the charging device 300, a sufficient voltage cannot be applied to the auxiliary DDC 200. In the case where a sufficient voltage cannot be applied to the auxiliary DDC 200, electric power cannot be supplied to the ECU 320 and the switch devices (the first switch device 301 to the third switch device 303), for example, during charging of the battery 106, which may result in a problem that the battery 106 cannot be charged. Moreover, there may arise a problem that electric power cannot be supplied to the in-vehicle air conditioner and the temperature conditioner for the battery 106.

In view of the above, the charging system 100 in the present embodiment opens the first switch device 301 and closes the second switch device 302 and the third switch device 303 (step S14). Further, the charging system 100 actuates both the PFC 154 and the insulated DCDC converter 170. Thus, the PFC 154 and the insulated DCDC converter 170 can step up the low voltage from the charger 113 and apply the resultant voltage to the DCF 300. The voltage generated in the DCF 300 (the voltage stepped up by the PFC 154 and the insulated DCDC converter 170) is applied to the auxiliary DDC 200.

Thus, the charging system 100 can supply stable electric power to the auxiliary group 108 regardless of the voltage of the battery 106 during charging of the battery 106. In particular, the charging system 100 can charge the battery 106 and supply electric power to the auxiliary DDC 200 even when the voltage of the battery 106 is lower than the predetermined value. Accordingly, the charging system 100 can suppress occurrence of the above-described problems.

In particular, in the present embodiment, the charging circuit 180 (particularly the PFC 154 and the insulated DCDC converter 170) used for AC charging is used as a voltage step-up circuit for DC charging. Therefore, the DC voltage from the charger 113 can be transformed without adding a special circuit to the charging device 300. That is, in the charging system 100 in the present embodiment, the charging circuit 180 for AC can be used as a circuit for DC. It is therefore unnecessary for the charging system 100 in the present embodiment to include the charging circuit 180 used for AC charging and a voltage step-up circuit for DC charging that are separate from each other. It is accordingly possible for charging system 100 in the present embodiment to have a reduced number of components as compared with the conventional charging systems.

(2) In the case where the supply voltage is the AC voltage, the charging system 100 performs the process of step S4. Thus, electric power can be supplied to the auxiliary DDC 200 and the battery 106.

### Embodiment 2

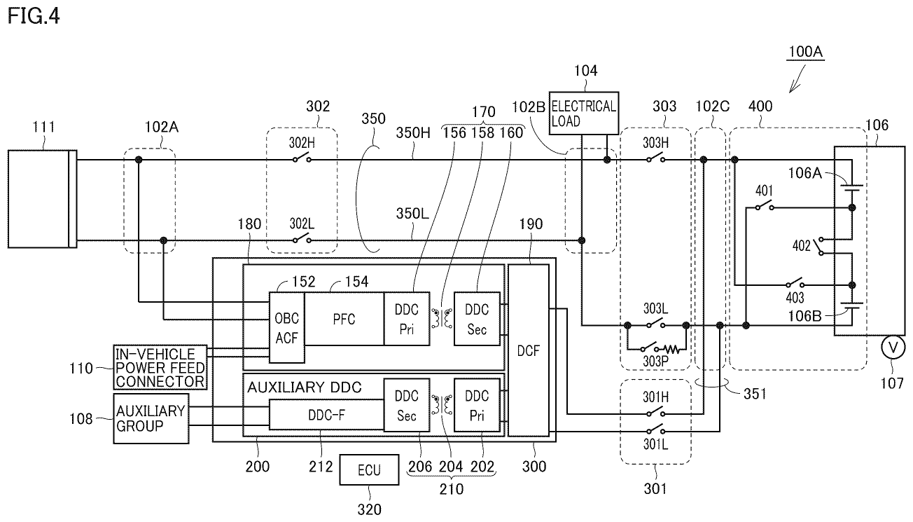

FIG. 4 illustrates an example configuration of a charging system 100A according to Embodiment 2. The battery 106 of the charging system 100A includes a first module 106A and a second module 106B. The first module 106A includes at least one cell. The second module 106B includes at least one cell. The first module 106A and the second module 106B have a voltage of 400 V, for example. The charging system 100A further includes a first switch circuit 400 including a first relay 401, a second relay 402, and a third relay 403.

One end of the first relay 401 is connected to the negative electrode side of the first module 106A, and the other end of the first relay 401 is connected to a low-voltage power line 350L (the negative electrode side of the second module 106B). One end of the second relay 402 is connected to the negative electrode side of the first module 106A, and the other end of the second relay 402 is connected to the positive electrode side of the second module 106B. One end of the third relay 403 is connected to the positive electrode side of the second module 106B, and the other end of the third relay 403 is connected to a high-voltage power line 350H (the positive electrode side of the first module 106A).

The first switch circuit 400 is a circuit that switches the state of the charging system 100A between a first state and a second state. The first state is a state in which the first module 106A and the second module 106B are connected in series between the pair of first power lines 350. The second state is a state in which the first module 106A and the second module 106B are connected in parallel to the pair of first power lines 350.

In the example in FIG. 4, the first state is a state in which the first relay 401 and the third relay 403 are opened and the second relay 402 is closed. The second state is a state in which the first relay 401 and the third relay 403 are closed and the second relay 402 is opened. The sensor 107 detects the voltage between the first power lines 350 of the pair as a voltage of the battery 106, in both the first state and the second state.

For driving the vehicle 1000 (for actuating the electrical load 104), for example, the ECU 320 closes the third switch device 303. Accordingly, electric power from the battery 106 is supplied to the electrical load 104. Further, for closing the third switch device 303, the ECU 320 sets the first switch circuit 400 to the first state (the state in which the first module 106A and the second module 106B are connected in series). Accordingly, in the charging system 100A, the first module 106A and the second module 106B are connected in series, and a large voltage can be supplied to the electrical load 104.

In the case where the DC voltage supplied from the external charger 113 to the first connector 111 is higher than a predetermined voltage, the ECU 320 sets the state of the first switch circuit 400 to the first state. The predetermined voltage is, for example, 600 V. The case where the DC voltage supplied to the first connector 111 is higher than the predetermined voltage is, for example, a case where the rated voltage of the DC voltage supplied from the charger 113 is 800 V. That is, in this case, the battery 106 is charged by the charger 113 adapted for a 800 V battery.

In contrast, there is also the case where the DC voltage supplied from the external charger 113 to the first connector 111 is lower than the predetermined voltage. This case is, for example, a case where the rated voltage of the DC voltage supplied from the charger 113 is 400 V. That is, in this case, the battery 106 is charged by the charger 113 adapted for a 400 V battery.

For charging with the charger 113 adapted for the 400 V battery, the ECU 320 sets the first switch circuit 400 to the second state (the state in which the first module 106A and the second module 106B are connected in parallel). Thus, the charging system 100A can charge both the first module 106A and the second module 106B with a lower voltage than that in the case where the first module 106A and the second module 106B are connected in series.

The ECU 320 can determine whether the DC voltage supplied from the charger 113 is 400 V or 800 V, by communicating with the charger 113.

It is supposed for example that each of the first module 106A and the second module 106B is constituted of 100 cells, and each cell of the 100 cells is used with 2.5 V to 4.2 V. In this case, the first module 106A and the second module 106B are connected in series when the battery 106 is being discharged, and therefore, the auxiliary DDC 200 needs to be designed to withstand application of a voltage of 500 V to 840 V.

The first module 106A and the second module 106B are connected in parallel when the battery 106 is being charged, and therefore, the auxiliary DDC 200 needs to be designed to withstand application of a voltage of 250 V to 420 V. That is, the auxiliary DDC 200 needs to be designed to withstand application of a voltage in a wide voltage range of 250 V to 840 V in practice. Regarding the conventional auxiliary DDC, if DC charging of 400 V is performed and the voltage of the battery 106 is low, it is difficult to design the auxiliary DDC 200 while making the design to withstand such a wide voltage range.

In contrast, in the present embodiment, the auxiliary DDC 200 can be designed, for example, to withstand application of a voltage in a voltage range of 500 V to 840 V, as illustrated below. This voltage range (500 V to 840 V) is a voltage range that can be applied to the auxiliary DDC 200 when the first module 106A and the second module 106B are connected in series (first state).

In this way, the auxiliary DDC 200 can be designed relatively easily. In addition, even when DC charging of 400 V is performed and the state is switched to the second state so that the voltage of the battery 106 is lower than the predetermined value, the charging system 100A steps up 400 V for the DC charging so as to belong to a range from 500 V to 840 V by the charging circuit 180 and supplies the resultant voltage to the auxiliary DDC 200. Thus, it is possible to supply sufficient electric power to the auxiliary DDC 200 and supply stable electric power to the auxiliary group 108, while making the voltage supplied to the auxiliary DDC 200 belonging to the voltage range (500 V to 840 V) for the withstand voltage design of the auxiliary DDC 200. Accordingly, the voltage range for the withstand voltage design of the auxiliary

DDC 200 can be made narrower.

In connection with Embodiment 1, it is described above that the predetermined condition regarding charging of the battery includes a condition that the voltage of the battery 106 is lower than a predetermined value. In Embodiment 2, the predetermined condition may be another condition. The other condition is described in the following.

It is apparent that the voltage of the battery 106 varies to a large extent depending on whether the state of the first switch circuit 400 is the first state or the second state. Therefore, the ECU 320 may determine that the voltage of the battery 106 is higher than the predetermined value when the state of the first switch circuit 400 is the first state. The ECU 320 may determine that the voltage of the battery 106 is lower than the predetermined value when the state of the first switch circuit 400 is the second state.

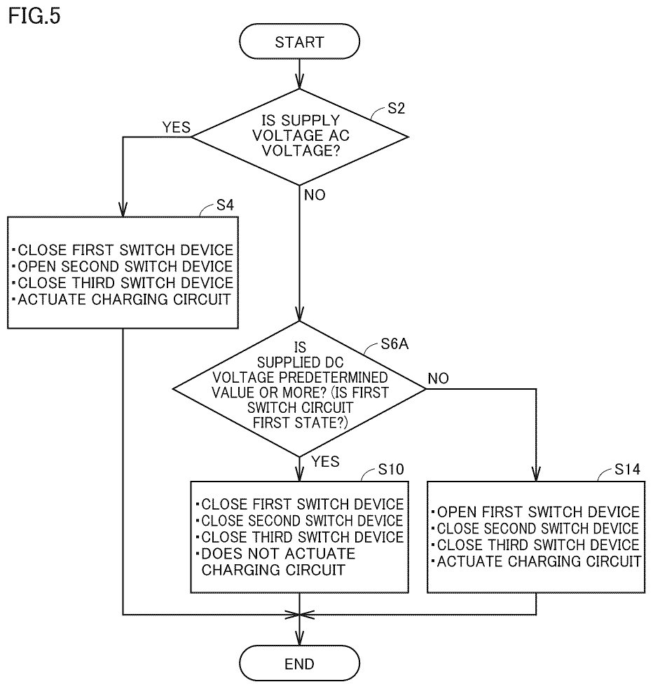

The predetermined condition including a condition that the DC voltage supplied to the first connector 111 is lower than a predetermined voltage (600 V) (that is, a condition that DC charging with 400 V is performed) may be adopted. FIG. 5 is a flowchart of a process performed by the ECU 320 in Embodiment 2 when such a feature as described above is adopted.

In FIG. 5, step S6 in FIG. 3 is replaced with step S6A, and step S8 and step S12 are not performed. In step S6A, the ECU 320 determines whether the DC voltage supplied to the first connector 111 is higher than or equal to a predetermined voltage. When the result of this determination is YES in step S6A, the ECU 320 performs the process of step S10 without performing the process of step S8. When the result of the determination is NO in step S6A, the ECU 320 performs the process of step S14 without performing the process of step S12.

In step S6A, the ECU 320 may determine whether or not the state of the first switch circuit 400 is the first state, as indicated in the parentheses of step S6A. When the result of the determination is YES in step S6A, the ECU 320 performs the process of step S10 without performing the process of step S8. When the result of the determination is NO in step S6A, the ECU 320 performs the process of step S14 without performing the process of step S12. The condition indicated in the parentheses of step S6A includes a condition that the state of the first switch circuit 400 is the second state.

### Embodiment 3

As the first module 106A and the second module 106B in FIG. 4 are discharged, the difference between the voltage of the first module 106A and the voltage of the second module 106B may increase. In this case, charging and discharging of the first module 106A and the second module 106B may not be performed appropriately and the battery capacity may not be used sufficiently. Moreover, the first module 106A and the second module 106B may be different from each other in terms of the number of cells. In Embodiment 3, an adjustment circuit addressing even a large difference between the voltage of the first module 106A and the voltage of the second module 106B is applied.

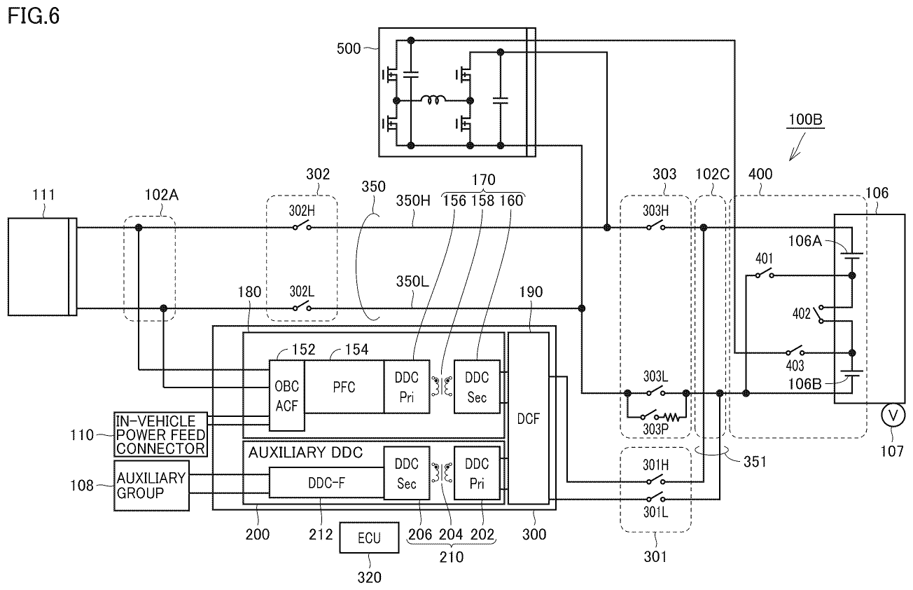

FIG. 6 illustrates an example configuration of a charging system 100B according to Embodiment 3. The charging system 100B corresponds to the charging system 100A in FIG. 4 to which an adjustment circuit 500 is added.

The adjustment circuit 500 transforms (steps up or steps down) the voltage of the pair of first power lines 350. In the second state, the adjustment circuit 500 applies the transformed voltage to the second module 106B. In FIG. 6, the adjustment circuit 500 is a step-up/down converter that steps up or steps down the voltage of the pair of first power lines 350.

With such a configuration, a voltage higher or lower than the voltage applied to the first module 106A can be applied to the second module 106B during DC charging, for example. Regarding the charging system 100B, a voltage adapted for the first module 106A may be output from the charger 113. Therefore, even when the difference between the voltage of the first module 106A and the voltage of the second module 106B is large, the charging system 100B can adapt to the difference. That is, the adjustment circuit 500 enables elimination of voltage imbalance, and enables charging even when there is a difference in the number of cells.

The adjustment circuit 500 is not limited to the step-up/down converter, and may also be an inverter or a motor, for example.

### Embodiment 4

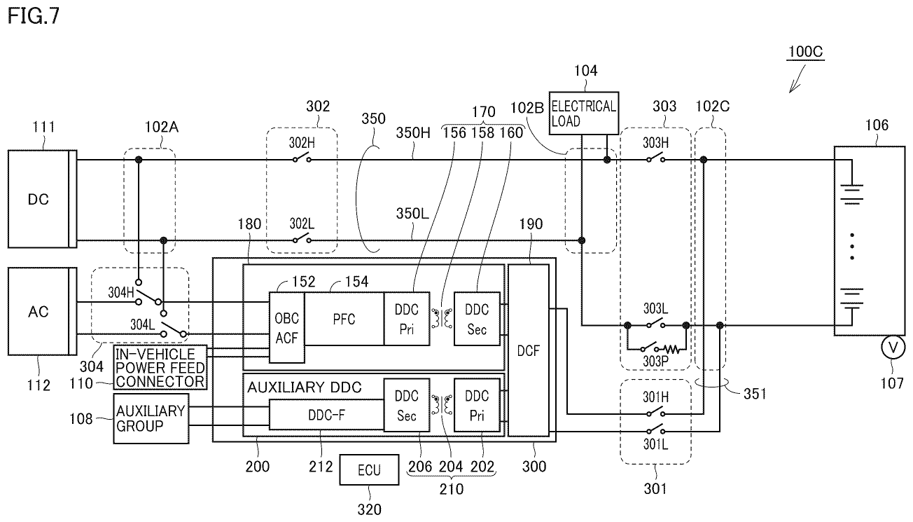

FIG. 7 illustrates an example configuration of a charging system 100C according to Embodiment 4. The charging system 100C includes a second connector 112 in addition to the first connector 111. A DC voltage is applied to the first connector 111 of the charging system 100C. An AC voltage is applied to the second connector 112 of the charging system 100C.

The charging system 100C also includes a second switch circuit 304 for switching the voltage input to the charging device 300 (charging circuit 180), that is, making a switch between the first connector 111 and the second connector 112. The second switch circuit 304 includes a high-voltage side relay 304H and a low-voltage side relay 304L.

In the case where the DC voltage is applied and the voltage of the battery 106 is lower than a predetermined value, the ECU 320 switches the second switch circuit 304 to a first state in which the first connector 111 and the charging device 300 are electrically connected to each other. In contrast, in the case where the AC voltage is applied, the second switch circuit 304 is switched to a second state in which the second connector 112 and the charging device 300 are electrically connected to each other. With such a configuration, the connector to which the DC voltage is applied and the connector to which the AC voltage is applied can be clearly distinguished from each other. Thus, the concept of the present disclosure is also applicable to a vehicle in which a connector to which a DC voltage is applied and a connector to which an AC voltage is applied are provided separately.

### Embodiment 5

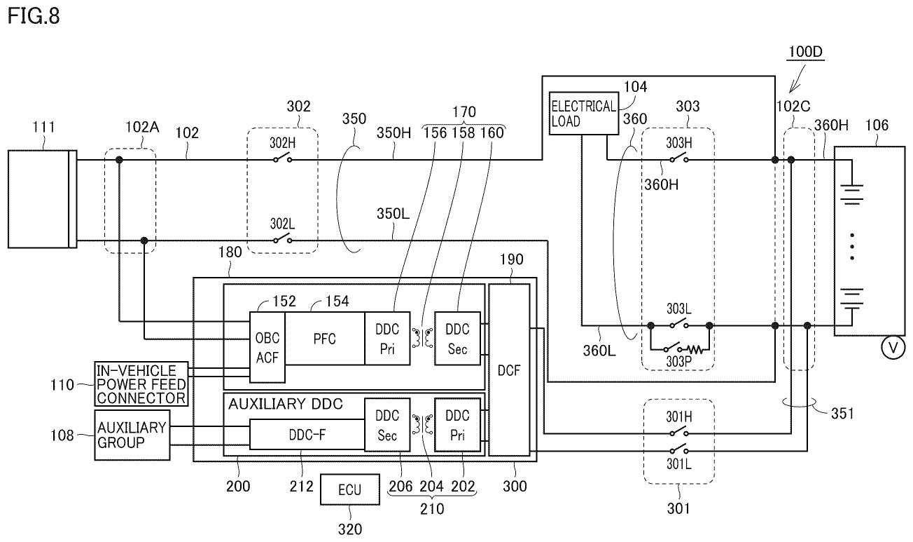

FIG. 8 illustrates an example configuration of a charging system 100D according to Embodiment 5. The charging system 100D further includes a pair of power lines 360. The pair of power lines 360 corresponds to “a pair of second power lines” of the present disclosure. Respective ones of the pair of power lines 360 connect respective first power lines 350 of the pair to the electrical load 104. Specifically, the pair of power lines 360 includes a high-voltage power line 360H and a low-voltage power line 360L. The high-voltage power line 350H and the high-voltage power line 360H are connected to each other, and the low-voltage power line 350L and the low-voltage power line 360L are connected to each other. Further, the third switch device 303 is disposed at the pair of power lines 360.

Further, for actuating the electrical load 104 (for driving the vehicle 1000, for example), the ECU 320 closes the third switch device 303. In contrast, for charging the battery 106, the ECU 320 opens the third switch device 303.

In the case of actuating the electrical load 104, the charging system 100D can appropriately apply the voltage to the electrical load 104. In contrast, in the case of charging the battery 106, the battery 106 and the electrical load 104 can be electrically insulated from each other.

### Embodiment 6

In connection with the foregoing embodiments, the example is described above where the same auxiliary DDC 200 is used during both discharging and charging of the battery 106. However, different auxiliary DDCs may be used respectively during discharging of the battery 106 and during charging of the battery 106.

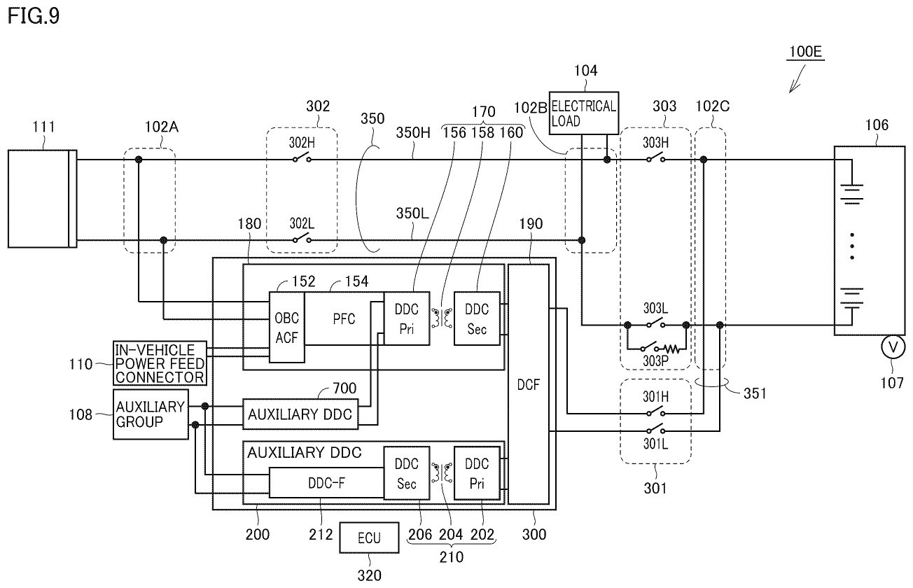

FIG. 9 illustrates an example configuration of a charging system 100E according to Embodiment 6. For the charging system 100E, a configuration is adopted in which a voltage can be supplied to an auxiliary DDC 700 from an intermediate part in the charging circuit 180. In other words, electric power can be supplied to the auxiliary DDC 700 from a so-called DC link voltage, on the insulated DCDC converter 170 side, of the PFC 154. For example, the auxiliary DDC 700 has the same configuration as the auxiliary DDC 200.

In the example in FIG. 9, the auxiliary DDC 700 can supply stable electric power to the auxiliary group 108, in the case where a DC voltage is supplied to the first connector 111, the voltage of the battery 106 is lower than a predetermined value, and the battery 106 is charged. In contrast, in the case where the battery 106 is discharged, the auxiliary DDC 200 supplies electric power to the auxiliary group 108.

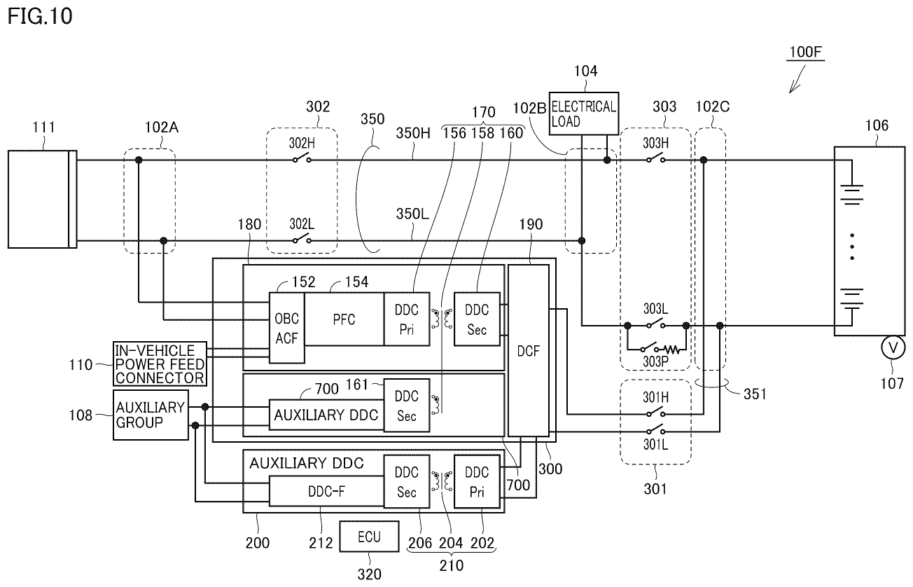

FIG. 10 illustrates an example configuration of another charging system 100F according to Embodiment 6. In the example in FIG. 10, a winding of a secondary circuit 161 separate from the charging circuit 180 is magnetically coupled to the iron core of the transformer 158, so that a voltage can be supplied to the secondary circuit 161. Then, a voltage can be supplied from the secondary circuit 161 to the auxiliary DDC 700.

The charging system for which such a configuration is adopted also produces advantageous effects similar to those of the foregoing embodiments.

### Embodiment 7

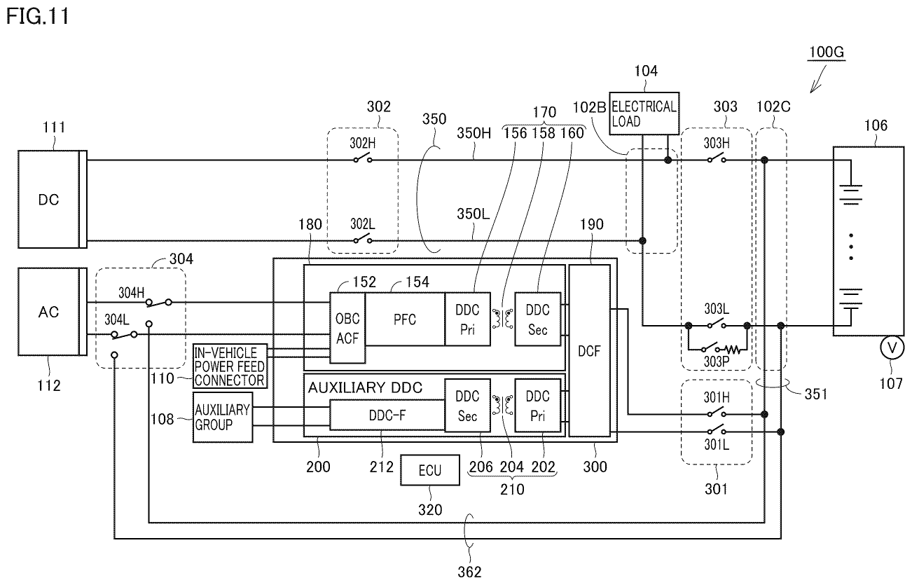

In connection with Embodiment 7, another example of FIG. 7 is described. FIG. 11 illustrates an example configuration of a charging system 100G according to a first example of Embodiment 7. The second state of the second switch circuit 304 in the charging system 100G is a state in which the second connector 112 and the OBCACF 152 are connected to each other (the state in FIG. 11). The first state of the second switch circuit 304 is a state in which the pair of first power lines 350 (branch power lines 351) and the OBCACF 152 (charging circuit 180) are connected, on the battery 106 side, to each other by power lines 362.

In the case of AC charging, the ECU 320 switches the second switch circuit 304 to the second state. Accordingly, the charging circuit 180 can convert the AC voltage into the DC voltage and supply the DC voltage to the auxiliary DDC 200 and the battery 106.

The ECU 320 switches the second switch circuit 304 to the first state, in the case where a DC voltage is supplied to the first connector 111, the voltage of the battery 106 is lower than a predetermined value, and the battery 106 is charged. In addition, the ECU 320 opens the first switch device 301. Accordingly, the DC voltage from the first connector 111 is stepped up by the charging circuit 180 through the power lines 362. Thus, the charging system 100G steps up the voltage from the battery 106 and supplies the resultant voltage to the auxiliary DDC 200, and can accordingly supply stable electric power to the auxiliary group 108.

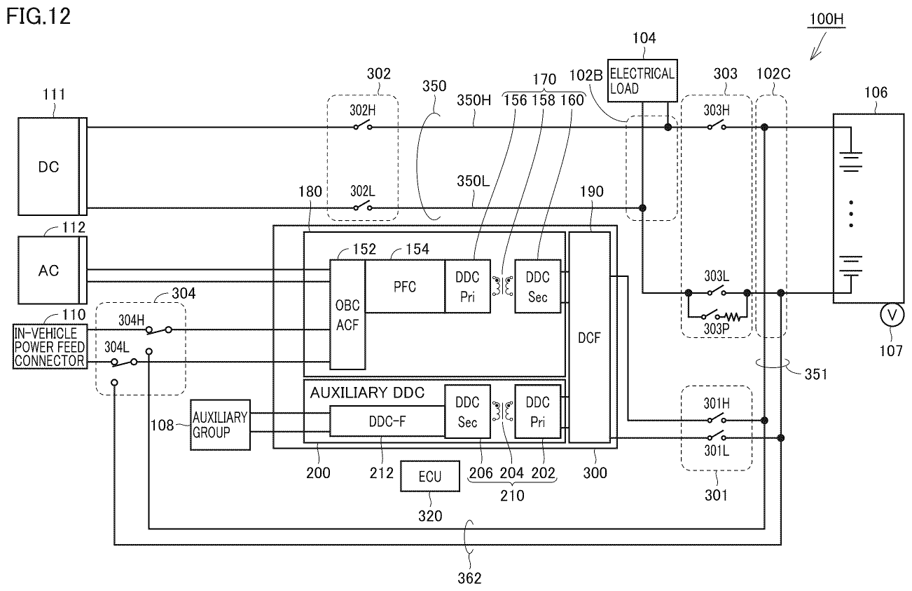

FIG. 12 illustrates an example configuration of a charging system 100H according to a second example of Embodiment 7. The second state of the second switch circuit 304 is a state in which the in-vehicle power feed connector 110 and the

OBCACF 152 are connected to each other (the state in FIG. 12). The first state of the second switch circuit 304 is a state in which the battery 106 and the OBCACF 152 (charging circuit 180) are connected to each other.

When the battery 106 is discharged, the ECU 320 switches the second switch circuit 304 to the second state. Accordingly, the OBCACF 152 of the charging circuit 180 supplies the AC voltage to the in-vehicle power feed connector 110.

The ECU 320 switches the second switch circuit 304 to the first state in the case where a DC voltage is supplied to the first connector 111, the voltage of the battery 106 is lower than a predetermined value, and the battery 106 is charged. In addition, the ECU 320 opens the first switch device 301. Accordingly, the DC voltage from the first connector 111 is stepped up by the charging circuit 180 through the power lines 362. Thus, the charging system 100H steps up the voltage from the battery 106 and supplies the resultant voltage to the auxiliary DDC 200, and can accordingly supply stable electric power to the auxiliary group 108.

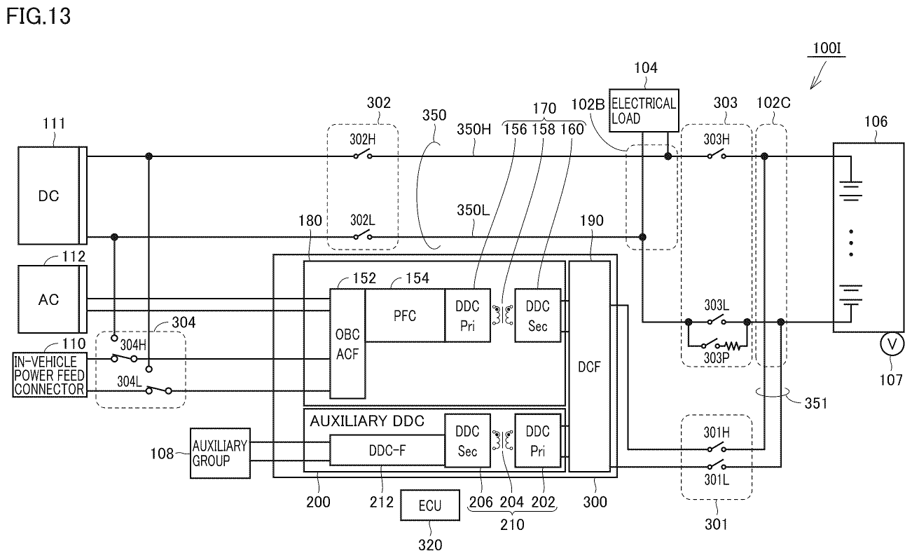

FIG. 13 illustrates an example configuration of a charging system 1001 according to a third example of Embodiment 7. The second state of the second switch circuit 304 is a state in which the in-vehicle power feed connector 110 and the OBCACF 152 are connected to each other (the state in FIG. 13). The first state of the second switch circuit 304 is a state in which the first connector 111 (DC connector) and the OBCACF 152 (charging circuit 180) are connected to each other.

For actuating the electrical load 104 (for driving the vehicle 1000, for example), the ECU 320 switches the second switch circuit 304 to the second state. In addition, the ECU 320 closes the first switch device 301. Accordingly, the DC voltage is supplied from the battery 106 to the in-vehicle power feed connector 110 and the auxiliary DDC 200 through the DCF 190.

The ECU 320 switches the second switch circuit 304 to the first state in the case where a DC voltage is supplied to the first connector 111, the voltage of the battery 106 is lower than a predetermined value, and the battery 106 is charged. Accordingly, the charging circuit 180 steps up the DC voltage and supplies the resultant DC voltage to the auxiliary DDC 200, to thereby supply stable electric power to the auxiliary group 108.

The charging system for which such a configuration is adopted also produces advantageous effects similar to those of the foregoing embodiments.

### Appendixes

(1) A vehicular charging system of the present disclosure is mounted on a vehicle. The charging system includes: a battery that stores electric power for generating driving force of the vehicle; a first connector to which at least a DC voltage is supplied from an external charger; and a pair of first power lines that connects the battery and the first connector to each other. The charging system also includes: a charging circuit that charges the battery by converting an AC voltage supplied from the external charger into a DC voltage and outputting the DC voltage to the pair of first power lines; an auxiliary DCDC converter that converts a voltage of the battery input from the pair of first power lines, and supplies the converted voltage to an auxiliary group including at least an auxiliary; a first switch device disposed between the pair of first power lines, and an output of the charging circuit and an input of the auxiliary DCDC converter; and a control circuit. The charging circuit include: a power factor correction circuit; and a charging DCDC converter that converts a DC voltage output from the power factor correction circuit. When a predetermined condition regarding charging of the battery is satisfied, the control circuit opens the first switch device to disconnect the pair of first power lines from the output of the charging circuit and the input of the auxiliary DCDC converter, supplies a DC voltage supplied to the first connector to the charging circuit, and actuates at least one of the power factor correction circuit and the charging DCDC converter, to thereby supply the DC voltage converted by the charging circuit to the auxiliary group.

With such a configuration, the charging circuit can convert, when an AC voltage is input from the external charger, the AC voltage into a DC voltage, and output the DC voltage to the pair of first power lines, to thereby charge the battery. When a DC voltage is input from the external charger, the charging circuit actuates at least one of the power factor correction circuit and the charging DCDC converter, to supply the DC voltage converted by the charging circuit to the auxiliary group. Thus, stable electric power can be supplied to the auxiliary group, regardless of the voltage of the battery.

(2) Regarding the vehicular charging system according to (1), the predetermined condition includes a condition that a voltage supplied to the first connector is a DC voltage and a voltage of the battery is lower than a predetermined value.

Such a configuration enables the DC voltage converted by the charging circuit to be supplied to the auxiliary group, even when the voltage of the battery is lower than the predetermined value.

(3) Regarding the vehicular charging system according to (2), when a voltage supplied to the first connector is a DC voltage and a voltage of the battery is higher than the predetermined value, the control circuit is configured to close the first switch device to supply the DC voltage from the pair of first power lines to the auxiliary group.

Such a configuration makes it unnecessary to use the charging circuit for charging, when a voltage of the battery is higher than the predetermined value, and therefore, it is possible to reduce losses due to operation of the charging circuit, and to feed electric power to the in-vehicle power feed connector by reverse operation of the charging circuit.

(4) Regarding the vehicular charging system according to (3), when a voltage supplied to the first connector is a DC voltage, the control circuit is configured to transmit, to the charger, a request signal for making a request to the charger for a start voltage that is a voltage at a start of charging the battery with the DC voltage. The start voltage requested by the request signal when the voltage of the battery is lower than the predetermined value is lower than the start voltage requested by the request signal when the voltage of the battery is higher than the predetermined value.

Such a configuration enables the DC voltage converted by the charging circuit to be supplied to the auxiliary group, regardless of the voltage of the battery, while suppressing damage to the battery.

(5) Regarding the vehicular charging system according to (1), the battery includes: a first module including at least one cell; and a second module including at least one cell. The vehicular charging system further includes a switch circuit that switches between a first state and a second state, in the first state the first module and the second module being connected in series between the pair of first power lines, in the second state the first module and the second module being connected in parallel to the pair of first power lines. The predetermined condition includes a condition that a DC voltage supplied to the first connector is lower than a predetermined voltage, or a condition that the switch circuit is in the second state.

Such a configuration enables narrowing of the voltage range for the withstand voltage of the auxiliary DCDC converter.

Moreover, the control circuit may set the state of the switch circuit to the first state when the DC voltage supplied to the first connector is higher than the predetermined voltage. The control circuit may set the state of the switch circuit to the second state when the DC voltage supplied to the first connector is lower than the predetermined voltage.

(6) Regarding the vehicular charging system according to (5), the vehicular charging system further includes an adjustment circuit that transforms a voltage of the pair of first power lines and applies the transformed voltage to the second module.

Such a configuration enables the battery to be charged depending on a difference between the voltage of the first module and the voltage of the second module, even when the difference is large.

(7) Regarding the vehicular charging system according to any one of (1) to (6), the vehicular charging system further includes a second switch device disposed at the pair of first power lines. When a voltage supplied to the first connector is an AC voltage, the control circuit is configured to close the first switch device, open the second switch device, and actuate the charging circuit. When a voltage supplied to the first connector is a DC voltage, the control circuit is configured to close the second switch device.

Such a configuration enables a voltage to be applied to the battery and the auxiliary DCDC converter, even when the voltage supplied from the first connector is an AC voltage.

(8) Regarding the vehicular charging system according to any one of (1) to (7), the first connector is configured to receive a DC voltage. The vehicular charging system further includes a second connector that receives an AC voltage.

Such a configuration makes it possible to clearly distinguish between the connector to which a DC voltage is applied and the connector to which an AC voltage is applied.

(9) Regarding the vehicular charging system according to any one of (1) to (8), the charging system further includes: an electrical load that generates driving force of the vehicle using electric power of the battery; a pair of second power lines connecting respective ones of the pair of first power lines to the electrical load; and a third switch device disposed at the pair of second power lines. For actuating the electrical load, the control circuit closes the third switch device. For charging the battery, the control circuit opens the third switch device.

With such a configuration, when the battery is discharged, the third switch device can be closed to supply electric power from the battery to the electrical load. When the battery is charged, the third switch device can be opened to prevent unnecessary electric power from being supplied to the electrical load.

It should be noted that, there is a possibility that a DC voltage is applied to the terminal of the second connector 112 or the in-vehicle power feed connector 110 in the circuit configuration of each embodiment, and therefore, a breaker function such as switch device or a switch circuit may be provided in the circuit of the OBCACF 152 and the PFC 154 or the line extending to the second connector 112 or the in-vehicle power feed connector 110.

While embodiments of the present disclosure have been described, it should be construed that the embodiments disclosed herein are given by way of illustration in all respects, not by way of limitation. It is intended that the scope of the present disclosure is defined by claims, and encompasses all modifications and variations equivalent in meaning and scope to the claims.

What is claimed is:

1. A vehicular charging system to be mounted on a vehicle, the vehicular charging system comprising:
a battery that stores electric power for generating driving force of the vehicle;
a first connector to which at least a DC voltage is supplied from an external charger;
a pair of first power lines that connects the battery and the first connector to each other;
a charging circuit that charges the battery by converting an AC voltage supplied from the external charger into a DC voltage and outputting the DC voltage to the pair of first power lines;
an auxiliary DCDC converter that converts a voltage of the battery input from the pair of first power lines, and supplies the converted voltage to an auxiliary group including at least an auxiliary;
a first switch device disposed between
the pair of first power lines, and
an output of the charging circuit and an input of the auxiliary DCDC converter; and
a control circuit,
the charging circuit comprising:
a power factor correction circuit; and
a charging DCDC converter that converts a DC voltage output from the power factor correction circuit, wherein
when a predetermined condition regarding charging of the battery is satisfied, the control circuit is configured to
open the first switch device to disconnect the pair of first power lines from the output of the charging circuit and the input of the auxiliary DCDC converter,
supply a DC voltage supplied to the first connector to the charging circuit, and
actuate at least one of the power factor correction circuit and the charging DCDC converter, to thereby supply the DC voltage converted by the charging circuit to the auxiliary group.

2. The vehicular charging system according to claim 1, wherein the predetermined condition includes a condition that a voltage supplied to the first connector is a DC voltage and a voltage of the battery is lower than a predetermined value.

3. The vehicular charging system according to claim 2, wherein when a voltage supplied to the first connector is a DC voltage and a voltage of the battery is higher than the predetermined value, the control circuit is configured to close the first switch device to supply the DC voltage from the pair of first power lines to the auxiliary group.

4. The vehicular charging system according to claim 3, wherein
when a voltage supplied to the first connector is a DC voltage, the control circuit is configured to transmit, to the charger, a request signal for making a request to the charger for a start voltage that is a voltage at a start of charging the battery with the DC voltage, and
the start voltage requested by the request signal when the voltage of the battery is lower than the predetermined value is lower than the start voltage requested by the request signal when the voltage of the battery is higher than the predetermined value.

5. The vehicular charging system according to claim 1, wherein the battery comprises:
a first module including at least one cell; and
a second module including at least one cell,
the vehicular charging system further comprises a switch circuit that switches between a first state and a second state, in the first state the first module and the second module being connected in series between the pair of first power lines, in the second state the first module and the second module being connected in parallel to the pair of first power lines, and
the predetermined condition includes a condition that a DC voltage supplied to the first connector is lower than a predetermined voltage, or a condition that the switch circuit is in the second state.

6. The vehicular charging system according to claim 5, further comprising an adjustment circuit that transforms a voltage of the pair of first power lines and applies the transformed voltage to the second module.

7. The vehicular charging system according to claim 1, further comprising a second switch device disposed at the pair of first power lines, wherein
when a voltage supplied to the first connector is an AC voltage, the control circuit is configured to close the first switch device, open the second switch device, and actuate the charging circuit, and
when a voltage supplied to the first connector is a DC voltage, the control circuit is configured to close the second switch device.

8. The vehicular charging system according to claim 1, wherein
the first connecter is configured to receive a DC voltage and
the vehicular charging system further comprises a second connector that receives an AC voltage.

9. The vehicular charging system according to claim 1, further comprising:
an electrical load that generates driving force of the vehicle using electric power of the battery;
a pair of second power lines connecting respective ones of the pair of first power lines to the electrical load; and
a third switch device disposed at the pair of second power lines, wherein
for actuating the electrical load, the control circuit closes the third switch device, and
for charging the battery, the control circuit opens the third switch device.

10. A charging circuit to be mounted on a vehicle including a battery that stores electric power for generating driving force of the vehicle, the charging circuit being a circuit that charges the battery,
the vehicle comprising:
a first connector to which at least a DC voltage is supplied from an external charger;
a pair of first power lines that connects the battery and the first connector to each other;
an auxiliary DCDC converter that converts a voltage of the battery input from the pair of first power lines, and supplies the converted voltage to an auxiliary group including at least an auxiliary; and
a first switch device disposed between
the pair of first power lines, and
an output of the charging circuit and an input of the auxiliary DCDC converter,
the charging circuit comprising:
a power factor correction circuit; and
a charging DCDC converter that transforms a DC voltage output from the power factor correction circuit, wherein
the charging circuit charges the battery by converting an AC voltage supplied from the external charger into a DC voltage and outputting the DC voltage to the pair of first power lines, and
when a predetermined condition regarding charging of the battery is satisfied, the charging circuit opens the first switch device to disconnect the pair of first power lines from the output of the charging circuit and the input of the auxiliary DCDC converter, supplies a DC voltage supplied to the first connector to the charging circuit, and actuates at least one of the power factor correction circuit and the charging DCDC converter, to thereby supply the DC voltage transformed by the charging circuit to the auxiliary group.

11. A charging device comprising the charging circuit according to claim 10, and the auxiliary DCDC converter.

12. A voltage control method for a vehicle,
the vehicle comprising:
a battery that stores electric power for generating driving force of the vehicle;
a first connector to which at least a DC voltage is supplied from an external charger;
a pair of first power lines that connects the battery and the first connector to each other;
a charging circuit that charges the battery by converting an AC voltage supplied from the external charger into a DC voltage and outputting the DC voltage to the pair of first power lines;
an auxiliary DCDC converter that converts a voltage of the battery input from the pair of first power lines, and supplies the converted voltage to an auxiliary group including at least an auxiliary; and
a first switch device disposed between
the pair of first power lines, and
an output of the charging circuit and an input of the auxiliary DCDC converter,
the charging circuit comprising:
a power factor correction circuit; and
a charging DCDC converter that transforms a DC voltage output the power factor correction circuit,
the voltage control method comprising, when a predetermined condition regarding charging of the battery is satisfied, opening the first switch device to disconnect the pair of first power lines from the output of the charging circuit and the input of the auxiliary DCDC converter, supplying a DC voltage supplied to the first connector to the charging circuit, and actuating at least one of the power factor correction circuit and the charging DCDC converter, to thereby supply the DC voltage transformed by the charging circuit to the auxiliary group.
